(19) United States
(12) Patent Application Publication
(10) Pub. No.: US 2007/0200360 A1
(43) Pub. Date: Aug. 30, 2007

(54) Latch arrangement

(76) Inventors: Dennis Cavallucci, Otterswiller (FR); Gurbinder Singh Kalsi, West Midlands (GB); Chris Rhodes, Orleans (FR); Nigel Victor Spurr, Solihull (GB); Sylvain Rehi Chonavel, Thury Harcourt (FR); David Peatey, Solihull (GB); Paul Moore, Kings Norton (GB); Robert Frank Tolley, Staffordshire (GB); Jean Vincent Olivier, Sully Sur Loire (FR); Robert James Clawley, Staffordshire (GB)

Correspondence Address: CARLSON, GASKEY & OLDS, P.C., 400 WEST MAPLE ROAD, SUITE 350, BIRMINGHAM, MI, 48009, US

(21) Appl. No.: 11/591,183

(22) Filed: Nov. 1, 2006

(30) Foreign Application Priority Data
Nov. 7, 2005 (GB) GB 0522666.7

(51) Int. Cl. E05C 3/06

(52) U.S. Cl. 292/216

(57) ABSTRACT

A latch arrangement includes a lever movable in response to movement of a door lever. A controller is configured for selectively preventing movement of the lever. The controller includes a mono-stable blocking element in the form of a bi-metallic strip which can be operated such that a distal end acts to block movement of the lever. The controller also includes a bi-stable blocking element having a nib that can be moved to an extended position to block movement of the lever. Both blocking elements can be operated at the same time. When either of the blocking elements are arranged in the path of the release lever, unlatching of the door is prevented.

### REFERENCE TO RELATED APPLICATIONS

This application claims priority to United Kingdom Patent Application GB 0522666.7 filed on Nov. 7, 2005.

### BACKGROUND OF THE INVENTION

The present invention relates generally to a latch arrangement, more particularly, but not exclusively, to a latch arrangement for use within a door of an automotive vehicle.

Known car doors include latches for releasably retaining the door in a closed position. The latches can be locked when the car is left unattended, or even when a vehicle is occupied to prevent access to the vehicle by unauthorized persons.

The latches can be moved between a locked condition and an unlocked condition either manually by operating an inside sill button or an exterior key barrel, or by powered actuation by a power actuator which can be controlled remotely by, for example, infrared devices.

A problem with such power locking/unlocking is that in the event that power is lost, e.g., during a road traffic accident or as a result of a dead battery, it may not be possible to change the state of the lock. Thus, if a vehicle is being driven with its door locked and the vehicle is then involved in a serious collision, the occupant of the vehicle may find themselves locked in the vehicle, which has safety implications.

A known form of door latch which addresses this problem is described in EP 1217153, where an electromagnet is utilized to prevent manual opening of the door when the vehicle is in use. In the event of a collision, a loss of power to the electromagnet enables the door to be manually opened.

It is an object of the invention to provide an improved form of a latch arrangement.

### SUMMARY OF THE INVENTION

The present invention provides a latch arrangement including a latch, a manually actuable element, a release mechanism and a power control system. The latch is operable to releasably retain a striker in use. The release mechanism is capable of being moved in response to movement of the manually actuable element from a latched position to an unlatched position where the release mechanism unlatches the latch. The power control system has a non-powered condition and a powered condition, and unlatching of the latch is prevented in the powered condition. The power control system has a first blocking element arranged for preventing movement of the release mechanism to the unlatched position in the powered condition and a second blocking element which is arranged for selectively preventing movement of the release mechanism to the unlatched position in the non-powered condition.

The term blocking element is intended to mean an element for providing a physical obstruction to a path of movement of an associated object, element, or device. That is, an element movable to a position in the path of the intended movement of the associated object, element, or device.

The present invention also provides a latch arrangement including a latch, a manually actuable element, a release mechanism and a power control system. The latch is operable to releasably retain a striker in use. The release mechanism is capable of being moved in response to movement of the manually actuable element from a latched position to an unlatched position where the release mechanism unlatches the latch. The power control system has a first condition in which the power control system is in a non-powered condition and actuation of the manually actuable element does not cause the release mechanism to unlatch the latch, a second condition in which the power control system is in a powered condition and actuation of the manually actuable element does not cause the release mechanism to unlatch the latch, and a third condition in which the power control system is in a non-powered condition and actuation of the manually actuable element causes the release mechanism to unlatch the latch. The power control system includes a mono-stable blocking element arranged for providing a physical obstruction in a path of movement of the release mechanism to prevent unlatching of the latch when the power control system is in a powered condition and to adopt a non-blocking position when the power control system is in a non-powered condition.

According to a still further aspect of the invention, a latch arrangement includes a latch, a manually actuable element, a release mechanism and a power control system. The latch is operable to releasably retain a striker in use. The release mechanism is capable of being moved in response to movement of the manually actuable element from a latched position to an unlatched position where the release mechanism unlatches the latch. The power control system has a first condition in which the power control system is in a non-powered condition and actuation of the manually actuable element does not cause the release mechanism to unlatch the latch, a second condition in which the power control system is in a powered condition and actuation of the manually actuable element does not cause the release mechanism to unlatch the latch, and a third condition in which the power control system is in a non-powered condition and actuation of the manually actuable element causes the release mechanism to unlatch the latch. The power control system includes a bi-stable actuator arranged for selectively providing a physical obstruction in the path of movement of the release mechanism to prevent unlatching of the latch when the power control system is in a non-powered condition.

### BRIEF DESCRIPTION OF THE DRAWINGS

Other aspects and features of the invention will be readily apparent from the dependent claims and the following description, which is made, by way of example only, with reference to the accompanying drawings in which:

FIG. 1 is a schematic view of a latch arrangement according to the present invention;

FIG. 1A is an enlarged view of part of the latch arrangement of FIG. 1 showing a primary blocking element in an energized position;

FIG. 1B is a view similar to FIG. 1A showing a secondary blocking element in a blocking position;

FIG. 2 shows the latch arrangement of FIG. 1 partially through an opening operation in an unlocked, but latched condition;

FIG. 3 shows the latch arrangement of FIG. 1 at the end of an opening operation in an unlatched condition; and

FIG. 4 shows the latch arrangement of FIG. 1 wherein an attempt has been made to open the latch while in a locked condition.

### DETAILED DESCRIPTION OF THE PREFERRED EMBODIMENT

With reference to the Figures, a latch arrangement 10 in accordance with a first preferred embodiment of the invention includes a latch 12 (only part of which is shown in the Figures), a release mechanism 16, a powered control system 18 and manually actuable elements in the form of an inside door handle 20 and an outside door handle 21.

Although not illustrated, the latch 12 is mounted on a car door and is operable to releasably retain a striker (not shown) mounted on a fixed structure of the car, such as a B post (not shown) or a C post (not shown). The latch 12 includes a latch bolt in the form of a rotating claw (not shown) for engaging the striker to hold the door in a closed position. A pawl arrangement (not shown) is provided for biasing the rotating claw into engagement with the striker, thereby retaining the rotating claw in a closed position. The pawl arrangement includes a latch release element.

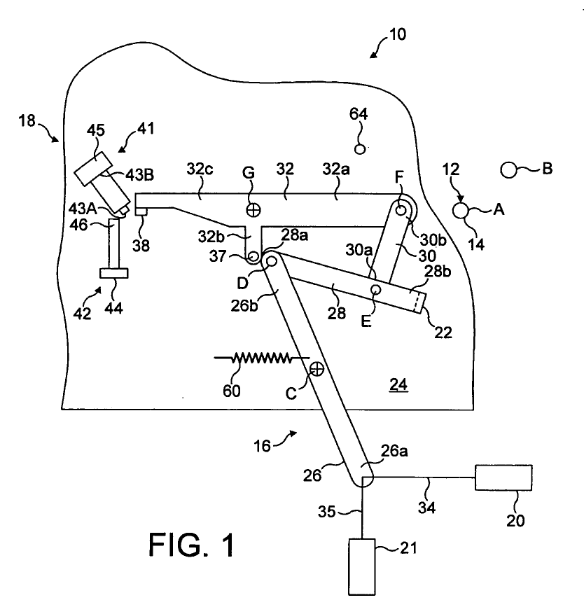

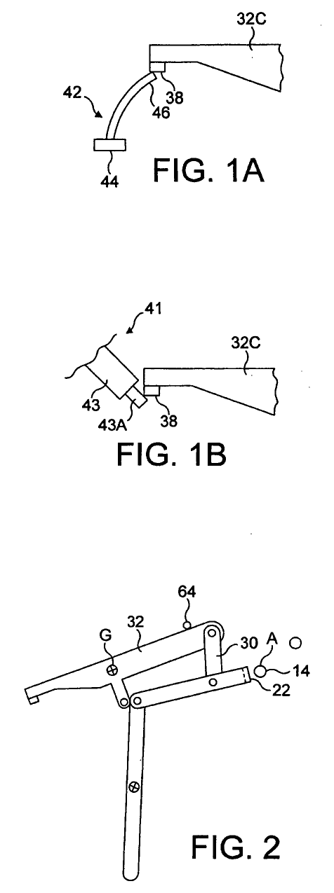

The latch release element, which in this embodiment is a pawl pin 14, is movable between a position A and a position B shown in FIG. 1. With the pawl pin 14 in the position A, closing of the door will cause the rotating claw to rotate and engage the striker. The pawl arrangement will then retain the striker in the closed position. Subsequent movement of the pawl pin 14 to the position B releases the pawl arrangement from engagement with the rotating claw, thus allowing the rotating claw to be released from the striker and thereby allowing the door to open. Thus, with the pawl pin 14 in the position A, the latch 12 can be “latched” to the striker, and with the pawl pin 14 in the position B, the latch 12 can be “unlatched” from the striker.

The release mechanism includes a release lever 26, a release link 28, a connector link 30 and a lock/unlock lever 32.

The release lever 26 is pivotally mounted about a pivot C on a chassis 24 of the latch arrangement 10. One end 26A of the release lever 26 is connected via a linkage 34 (shown schematically) to a first manually actuable element in the form of the inside door handle 20. The end 26A is also connected by a further linkage 35 (shown schematically) to a second manually actuable element in the form of an outside door handle 21.

Operation of either the inside door handle 20 or the outside door handle 21 causes the release lever 26 to rotate clockwise about the pivot C. An opposite end 26B of the release lever 26 is connected via a pivot D to an end 28A of the release link 28. An opposite end 28B of the release link 28 includes an abutment 22 for engagement with the pawl pin 14, as will be further described below.

The release link 28 is connected to an end 30A of the connector link 30 by a pivot E, which is positioned between the two ends 28A and 28B of the release link 28. An end 30B of the connector link 30 is connected to the end of a first arm 32A of the lock/unlock lever 32 by a pivot F.

The lock/unlock lever 32 further includes a second arm 32B having a pin 37 and a third arm 32C having an abutment 38 on an underside. The lock/unlock lever 32 is pivotally mounted about a pivot G onto the chassis 24 of the latch arrangement 10.

The powered control system 18 includes a primary blocking element 42, which in this embodiment is in the form of (or incorporates) a bimetallic strip. The primary blocking element 42 is arranged for operative engagement with the abutment 38 for preventing downward movement of the third arm 32C of the lock/unlock lever 32. In particular, the primary blocking element 42 is arranged in the manner of a cantilever having a fixed end 44 and a free end 46. The free end 46 is arranged for movement between an operative blocking position, e.g., as shown in FIG. 1A, and an inoperative position, e.g., as shown in FIG. 1.

In an alternative embodiment, the primary blocking element 42 is in the form of (or incorporates) a piezoelectric beam. Similarly, the piezoelectric beam will typically be arranged in the manner of a cantilever to define a fixed end and a free end. The free end is arranged for movement between an operative blocking position and an inoperative, non-blocking position in which the lock/unlock lever 32 is free to move.

The primary blocking element 42, whether in the form of a piezoelectric beam or a bi-metallic strip, is monostable and only adopts the blocking position when power is supplied thereto. Therefore, in the absence of power to the powered control system 18, the primary blocking element 42 will adopt the inoperative, non-blocking position and remain stable in the position until power is resumed.

The powered control system 18 also includes a secondary blocking element 41 in the form of a linear actuator. In this embodiment, the secondary blocking element 41 consists of a bi-stable actuator 43 (of generally known construction) which is arranged in communication with a mono-stable solenoid actuator 45. The bi-stable actuator 43 includes a nib-like portion 43A which is movable between a retracted position and an extended position in response to a mechanical input from the solenoid actuator 45. In particular, the solenoid actuator 45 is adapted to selectively engage a free end 43B of the bi-stable actuator 43 to cause the nib-like portion 43A to move between the retracted position and an extended position. Moreover, the nib-like portion 43A is selectively movable into a blocking position when extended to provide blocking engagement with the abutment 38, as shown in FIG. 1B. In the blocking position, the nib-like portion 43A prevents counter-clockwise rotation of the lock/unlock lever 32, as viewed in FIG. 1B. Hence, when the nib-like portion 43A is in the extended position, the latch 12 is prevented from opening.

The nib-like portion 43A is maintained in a stable condition in both the extended position and the retracted position and will therefore not change from the blocking position to a non-blocking position, and vice versa, in the absence of power to the powered control system 18.

The primary blocking element 42 and the secondary blocking element 41 are off-set from one another or otherwise cooperatively arranged so that a free end 46 of the primary blocking element 42 and the nib-like portion 43A of the secondary blocking element 41 are simultaneously engagable with the end of the lock/unlock lever 32 to prevent counter-clockwise rotation thereof, as viewed in FIG. 1.

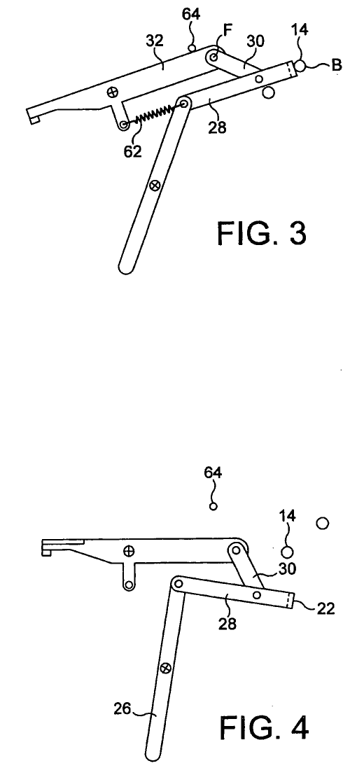

A tension spring 60 is connected between the chassis 24 and the release lever 26, which acts to bias the release lever 26 in a counter-clockwise direction, as viewed in FIG. 1. A further tension spring 62 (only shown in FIG. 3 for clarity) biases the pin 37 and the pivot E together. In further embodiments, different forms of springs can be used, in particular springs acting in torsion (clock springs), in place of tension springs 60 and 62 to perform the same biasing action.

A lock/unlock lever stop 64 is mounted on the chassis 24. As a result of the further tension spring 62, the end 28A of the release link 28 is biased into engagement with the pin 37. In further embodiments, the end 26A of the release lever 26 could engage the pin 37, as could a part of the pivot D.

The fixed end 44 of the primary blocking element 42 is arranged in electrical communication with a vehicle ECU. More particularly, the vehicle ECU is configured to energize the primary blocking element 42 to cause the bimetallic strip to flex and cause the primary blocking element 42 to be held in an operative position. When the primary blocking element 42 is in the operative position, the lock/unlock lever 32 is prevented from counter-clockwise rotation, when viewed in FIG. 1A, about the pivot G (see below). However, when the primary blocking element 42 is not energized, it adopts the inoperative position so that the lock/unlock lever 32 is free to rotate.

The piezoelectric beam of an alternative embodiment referred to above is configured to move in a similar manner from the inoperative position to the operative position upon energization. In both cases, the piezoelectric beam and the bimetallic strip will cause the primary blocking element 42 to return to the inoperative position immediately in the absence of power thereto.

The powered control system 18 has four conditions. In a first condition, no power is applied to the primary blocking element 42, and the secondary blocking element 41 is in the blocking position, as shown in FIG. 1B. In a second condition, power is supplied and maintained to the primary blocking element 42, thereby blocking rotation of the lock/unlock lever 32 (see FIG. 1A). The secondary blocking element 41 is in the non-blocking position, as shown in FIG. 1. In a third condition, no power is supplied to the primary blocking element 42, and the secondary blocking element 41 is in the non-blocking position, as shown in FIG. 1. In a fourth condition, power is supplied to the primary blocking element 42 to adopt the position shown in FIG. 1A, and the secondary blocking element 41 is in the blocking position, as shown in FIG. 1B.

The present invention also can relate to the latch arrangement 10 incorporating a powered control system 18 having these four conditions.

Operation of the latch arrangement 10 is as follows. The door can be manually opened only when the lock/unlock lever 32 is able to rotate counter-clockwise, i.e., when the powered control system 18 is in the third condition such that the primary blocking element 42 and the secondary blocking element 41 are in their inoperative or non-blocking positions.

In the third condition, initial movement of either the inside door handle 20 or the outside door handle 21 moves the release lever 26 in a clockwise direction about the pivot C to the unlocked position, as shown in FIG. 2. The lock/unlock lever 32 has rotated counter-clockwise about the pivot G to a position where the first arm 32A has come into abutment with the lock/unlock lever stop 64.

As shown in FIG. 2, the end 28A of the release link 28 has remained in contact with the pin 37. Thus, the connector link 30 and the release link 28 have also substantially rotated about the pivot G. As shown in FIG. 2, the abutment 22 has become aligned with the pawl pin 14. This can be contrasted with the position of the abutment 22 as shown in FIG. 1 where the abutment 22 is not aligned with the pawl pin 14. Further movement of the inside door handle 20 or the outside door handle 21 moves the release lever 26 from the position as shown in FIG. 2 to the position as shown in FIG. 3.

In view of the fact that the first arm 32A of the lock/unlock lever 32 is in abutting engagement with the lock/unlock lever stop 64, the lock/unlock lever 32 cannot rotate further in a counter-clockwise direction. Thus, the connector link 30 is caused to rotate counter-clockwise about a pivot F relative to the lock/unlock lever 32. This results in the abutment 22 of the release link 28 moving into engagement with the pawl pin 14 and moving the pawl pin 14 from the position A shown in FIG. 2 to the position B shown in FIG. 3. As previously mentioned, movement of the pawl pin 14 from the position A to the position B causes the latch 12 to unlock.

When the inside door handle 20 and the outside door handle 21 are released, the springs 60 and 62 return the release mechanism 16 and the pawl pin 14 to the position as shown in FIG. 1.

While the movement of the inside door handle 20 or the outside door handle 21, and hence the movement of the release lever 26, has been described in two stages, such two stage movement is not discernible by a person operating the inside door handle or the outside door handle 21. Furthermore, the mechanism is designed to move seamlessly from the position shown in FIG. 3 to the position shown in FIG. 1.

With the powered control system 18 in the first condition, the second condition or the fourth condition, the lock/unlock lever 32 is maintained in the position shown in FIG. 1 by blocking engagement with the primary blocking element 42 and/or the secondary blocking element 41, as applicable.

Thus, operation of an inside door handle 20 or the outside door handle 21 will cause the release lever 26 to rotate in a clockwise direction as shown in FIG. 1, which will result in the end 28A of the release link 28 immediately disengaging the pin 37 such that the release lever 26, the release link 28 and the connector link 30 move to the position shown in FIG. 4. The primary blocking element 42 and/or the secondary blocking element 41 are not shown in FIG. 4, for ease of illustration.

While the abutment 22 is being caused to move, in view of the fact that it was initially misaligned with the pawl pin 14, such movement has resulted in the abutment 22 bypassing the pawl pin 14 and not imparting any movement to the pawl pin 14. Thus, while the inside door handle 20 or the outside door handle 21 has been moved, the door has not become unlatched. Hence, with the powered control system 18 in the first condition, the second condition or the fourth condition, the latch 12 remains in a locked condition.

The latch arrangement 10 is configured such that when the associated vehicle is in use, the powered control system 18 is set to the second condition, i.e., power is maintained to the primary blocking element 42, to prevent unauthorized opening of the door. Under such circumstances, any electric power lost to resistance can be compensated for by the fact that the engine of the vehicle is running, and hence the battery recharging system (such as an alternator) can recharge the battery to ensure it does not go dead.

When the vehicle is parked and left unattended, the powered control system 18 can be set to the first condition to lock the latch 12. The powered control system 18 does not cause any drain to the vehicle battery in the first condition.

The powered control system 18 can also be set to the third condition when the vehicle is parked and is required to be in an unlocked condition. In the third condition, there is no drain on the battery. The powered control system 18 can be changed between the first condition and the third condition by applying a pulse of electrical power to the solenoid actuator.

With the vehicle in use and the powered control system 18 in the second condition, as mentioned above, the lock/unlock lever 32 is maintained in the position shown in FIG. 1 by power being fed to the primary blocking element 42. In the event of a power failure, such as might occur following a road traffic accident, the powered control system 18 will by definition change to the third condition, and hence the doors will become unlocked and occupants of the vehicle will be able to escape from the vehicle. Only when the vehicle is in use is power continually fed to the primary blocking element 42.

As mentioned above, the powered control system 18 has two ways of preventing rotation of the lock/unlock lever 32, namely by permanently energizing the primary blocking element 42 or by movement of the secondary blocking element 41 to the position shown in FIG. 1B.

In some embodiments, it may be preferred to replace the primary blocking element 42 with the electromagnet arrangement shown in EP 1217153, which arrangement is incorporated herein by reference. As such, at least a distal portion of the lock/unlock lever 32 will need to be made from a ferromagnetic material, for example mild steel, for attraction by the electromagnet. When power is supplied to the powered control system 18, the electromagnet is energized and attracts the end of the lock/unlock lever 32, thereby preventing counter-clockwise rotation of the lock/unlock lever 32 as viewed in FIG. 1 to prevent opening of the latch 12. However, in the event of loss of power to the electromagnet, the lock/unlock lever 32 will be free to rotate, unless otherwise prevented from movement by the secondary blocking element 41.

The electromagnet need only be strong enough to retain the lock/unlock lever 32 in the position shown in FIG. 1 when power is being supplied to the electromagnet. Thus, the electromagnet would have to be strong enough to overcome the forces in the tension spring 60 during initial movement of the inside door handle 20 or the outside door handle 21, and it has to overcome the forces in the tension springs 60 and 62 during a subsequent movement of the inside door handle 20 or the outside door handle 21. The electromagnet would not be required to be strong enough to move the lock/unlock lever 32 from the position as shown in FIG. 2 to a position such that the abutment 38 would engage with the electromagnet.

The secondary blocking element 41 may take the form of a rotatable element, for example a permanent magnet arrangement such as that described in EP 1217153, which arrangement is incorporated herein by reference. The magnet would be movable between a first position in which the lock/unlock lever 32 would be free to rotate to allow the latch 12 to be opened and a second position in which an end of the magnet would be arranged in blocking engagement with the distal end of the lock/unlock lever 32 to prevent rotation thereof, thereby preventing opening of the latch 12. A mechanism for selectively rotating the secondary blocking element 41 to the blocking position is known in the art.

The invention does not contemplate an embodiment which uses a rotatable permanent magnet with an electromagnet arranged in place of the primary blocking element 42 described above.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

1. A latch arrangement comprising:
a latch operable to releasably retain a striker in use;
a manually actuable element;
a release mechanism capable of being moved in response to movement of the manually actuable element from a latched position to an unlatched position wherein the release mechanism unlatches the latch; and
a power control system having a non-powered condition and a powered condition, wherein unlatching of the latch is prevented in the powered condition,
wherein the power control system has a first blocking element arranged for preventing movement of the release mechanism to the unlatched position when the power control system is in the powered condition and a second blocking element which is arranged for selectively preventing movement of the release mechanism to the unlatched position when the power control system is in the non-powered condition.

2. The latch arrangement according to claim 1, wherein the first blocking element and the second blocking element are respectively arranged for providing a physical obstruction in a path of movement of the release mechanism to prevent unlatching of the latch.

3. The latch arrangement according to claim 1, wherein the first blocking element comprises a cantilever having a free end, the free end of the cantilever having a non-blocking position wherein the release mechanism is free to move to the unlatched position; and a blocking position wherein the release mechanism is prevented from moving to the unlatched position, and the free end is arranged to move to the blocking position when the power control system is in the powered condition.

4. The latch arrangement according to claim 3, wherein the first blocking element comprises one of a piezoelectric beam and a bi-metallic strip.

5. The latch arrangement according to claim 1, wherein the first blocking element is monostable and configured to adopt a non-blocking position when the power control system is in the non-powered condition.

6. The latch arrangement according to claim 1, wherein the second blocking element comprises a linear actuator having a blocking portion which is selectively movable between a blocking position wherein the release mechanism is prevented from moving to the unlatched positions and a non-blocking position wherein the release mechanism is free to move to the unlatched position.

7. The latch arrangement according to claim 6, wherein the second blocking element includes a solenoid for movement of the blocking portion between the blocking position and the non-blocking position.

8. The latch arrangement according to claim 6, wherein the second blocking element is bi-stable to be capable of retaining the blocking portion in the blocking position when the power control system is in the non-powered condition.

9. The latch arrangement according to claim 1, wherein the release mechanism includes a movable element having an abutment, and the first blocking element and the second blocking element are arranged to be simultaneously engagable with the abutment for preventing movement of the movable element.

10. A latch arrangement comprising:
a latch operable to releasably retain a striker in use;
a manually actuable element;
a release mechanisms capable of being moved in response to movement of the manually actuable element from a latched position to an unlatched position wherein the release element unlatches the latch, and;
a power control system having a first condition wherein the power control system is in a non-powered condition and actuation of the manually actuable element does not cause the release mechanism to unlatch the latch, a second condition wherein the power control system is in a powered condition and actuation of the manually actuable element does not cause the release mechanism to unlatch the latch, and a third condition wherein the power control system is in the non-powered condition and actuation of the manually actuable element causes the release mechanism to unlatch the latch, and
wherein the power control system includes a mono-stable blocking element arranged for providing a physical obstruction in a path of movement of the release mechanism to prevent unlatching of the latch when the power control system is in the powered condition and to adopt a non-blocking position when the power control system is in the non-powered condition.

11. A latch arrangement comprising:
a latch operable to releasably retain a striker in use;
a manually actuable element;
a release mechanism capable of being moved in response to movement of the manually actuable element from a latched position to an unlatched position wherein the release mechanism unlatches the latch; and
a power control system having;
a first condition wherein the power control system is in a non-powered condition and actuation of the manually actuable element does not cause the release mechanism to unlatch the latch, a second condition wherein the power control system is in a powered condition and actuation of the manually actuable element does not cause the release mechanism to unlatch the latch, and a third condition wherein the power control system is in the non-powered condition and actuation of the manually actuable element causes the release mechanism to unlatch the latch, and
wherein the power control system includes a bi-stable actuator arranged for selectively providing a physical obstruction in a path of movement of the release mechanism to prevent unlatching of the latch when the power control system is in the non-powered condition.
